(19) United States
(12) Patent Application Publication
(10) Pub. No.: US 2023/0061816 A1
(43) Pub. Date: Mar. 2, 2023

(54) Air-coupled Ultrasonic Detection Method and Device Based on Defect Probability Reconstruction Algorithm

(71) Applicant: Harbin Institute of Technology, Harbin (CN)

(72) Inventors: Weijia Shi, Harbin (CN); Bingquan Wang, Harbin (CN); Bo Zhao, Harbin (CN); Jiubin Tan, Harbin (CN)

(21) Appl. No.: 17/552,493

(22) Filed: Dec. 16, 2021

(30) Foreign Application Priority Data
Sep. 2, 2021 (CN) 2021110269495

(51) Int. Cl. G01N 29/44; G01N 29/06; G01N 29/22; G01N 29/34

(52) U.S. Cl. CPC G01N 29/4472; G01N 29/069; G01N 29/221; G01N 29/348

(57) ABSTRACT

The disclosure discloses an air-coupled ultrasonic detection method and device based on a defect probability reconstruction algorithm. The method includes the following steps: determining the excitation frequency of a transmitting air-coupled transducer according to a frequency dispersion curve of guided waves and the thickness of a to-be-detected piece; determining the group velocity of an antisymmetric mode according to the excitation frequency, and determining the inclination angle of the transmitting/receiving air-coupled transducer according to the Snell law; obtaining an initial waveform of a defect-free test piece as reference data by adopting a same-side penetration method, then rotating the transmitting/receiving transducer by 360 degrees by taking the Z direction as an axis at preset angle intervals by adopting a rotary scanning method, collecting N groups of signal data of the to-be-detected piece again, comparing the N groups of signal data with the reference data to determine whether the signal characteristics have great changes or not, calculating the defect distribution probability on the to-be-detected piece, and carrying out defect imaging on a rotating coverage area of the transmitting/receiving air-coupled transducer according to the defect distribution probability. According to the method, the precision of traditional air-coupled ultrasonic X and Y scanning detection is improved, and compared with a complex imaging technology, the air-coupled ultrasonic detection method consumes less time.

### TECHNICAL FIELD

The disclosure relates to the technical field of ultrasonic detection, and in particular to an air-coupled ultrasonic detection method and device based on a defect probability reconstruction algorithm.

### BACKGROUND

Along with progress of science and technology, market development and change of scientific research requirements, conventional materials cannot meet certain harsh requirements, so that engineering application is hindered. In order to overcome this difficulty and realize materials for specific application scenarios, composite materials are produced. The composite material has high specific strength and specific rigidity, and can be designed and customized; the fatigue resistance of the composite material is superior to that of a traditional material; the vibration reduction capacity is high; the performance is stable under the condition of high temperature; excellent properties such as good stability and safety have been widely applied to various industries; and the composite material is used everywhere from military aerospace to civil automobile and medical treatment.

Along with expansion of the application range of the composite material, the application environment of the composite material is more and more complex and harsher, so that damage of the composite material caused by factors such as vibration, impact and fatigue in the service process is more and more obvious, and in addition, congenital defects or some material defects are inevitably caused in the production and processing courses, so that nondestructive testing on the composite material is very necessary to avoid engineering loss caused by failure of the composite material.

Air-coupled ultrasound is a novel ultrasonic detection method, has the outstanding advantages compared with the traditional ultrasonic detection that a coupling agent does not need to be applied in the detection process, and has unique advantages on certain detection occasions with special requirements or detection of special materials, such as composite materials, medicinal materials, wood materials and the like which are not suitable for being detected by using the coupling agent. Traditional ultrasound has to be transmitted to a detected object through a coupling agent after being excited by a transducer to guarantee maximum transmission of energy, however, the materials may be polluted or even damaged, so that use of ultrasonic detection is limited to a certain extent; the air-coupled ultrasound well solves the problems, sound waves can be directly transmitted out through air, and non-contact nondestructive detection is completed. The air-coupled ultrasound has good adaptability to complex geometric components, and therefore the air-coupled ultrasound has great significance in research of the complex geometric components.

At present, a different-side vertical penetration method is usually adopted for carrying out air-coupled ultrasonic detection on a to-be-detected piece in the market, and a scanning mechanism is used to carry out X-direction and Y-direction scanning on a transmitting air-coupled transducer and a receiving air-coupled transducer, so that two-dimensional plane imaging detection is realized. According to the different-side vertical penetration method, the transmitting air-coupled transducer and the receiving air-coupled transducer need to be placed at two sides of the to-be-detected piece, and the requirement cannot be met for some in-service actual detection scenes. Meanwhile, defect two-dimensional imaging through X-direction and Y-direction scanning cannot meet the requirement for detection precision, and missing detection is easily caused for some small defects. Although accurate defect images may be obtained through defect detection, growth monitoring and localization mapping of guided wave arrays using computed tomography techniques and utilizing wave velocity, attenuation, or energy as features of image reconstruction, these methods are quite time consuming, and the sensitivity of sparse sensors is unsatisfactory.

### SUMMARY

The disclosure aims to solve one of the technical problems in the related art at least to a certain extent.

Therefore, one purpose of the disclosure is to provide an air-coupled ultrasonic detection method based on a defect probability reconstruction algorithm, which improves the precision of traditional air-coupled ultrasonic X and Y scanning detection, and consumes less time compared with a complex imaging technology.

Another purpose of the disclosure is to provide an air-coupled ultrasonic detection device based on a defect probability reconstruction algorithm.

In order to achieve the purposes, on one hand, an embodiment of the disclosure provides an air-coupled ultrasonic detection method based on a defect probability reconstruction algorithm, which includes the following steps: step S1, determining the excitation frequency of a transmitting air-coupled transducer according to a frequency dispersion curve of guided waves and the thickness of a to-be-detected piece; step S2, determining the group velocity of an antisymmetric mode according to the excitation frequency, and determining the inclination angle of the transmitting air-coupled transducer and a receiving air-coupled transducer according to the Snell law; step S3, placing a transmitting air-coupled transducer and a receiving air-coupled transducer on the same-side upper surface of a defect-free test piece according to the inclination angle, and obtaining an initial waveform of the defect-free test piece as reference data by adopting a same-side penetration method; step S4, placing the transmitting air-coupled transducer and the receiving air-coupled transducer on the same-side upper surface of the to-be-detected piece according to the inclination angle, and obtaining N groups of signal data of the to-be-detected piece by adopting a rotary scanning method; and step S5, comparing the reference data with the N groups of signal data, solving N signal change correlation coefficients, processing the N signal change correlation coefficients based on the defect probability reconstruction algorithm to obtain defect distribution probability on the to-be-detected piece, and carrying out defect imaging on a rotating coverage area of the transmitting air-coupled transducer and the receiving air-coupled transducer according to the defect distribution probability.

According to the air-coupled ultrasonic detection method based on the defect probability reconstruction algorithm in the embodiment of the disclosure, the accuracy of traditional air-coupled ultrasonic X and Y scanning detection is improved; compared with a complex imaging technology, the air-coupled ultrasonic detection method consumes less time; and under the same environment and measurement conditions, the change is caused by the generation of defects. According to the embodiment of the disclosure, the defect growth may be monitored by tracking increase of the signal difference relative to the normal condition, and the fact health monitoring of the to-be-detected piece is realized.

In addition, the air-coupled ultrasonic detection method based on the defect probability reconstruction algorithm according to the embodiment of the disclosure may further have the following additional technical features.

Further, in an embodiment of the disclosure, the step S4 specifically includes: step S401, placing the transmitting air-coupled transducer and the receiving air-coupled transducer on the same-side upper surface of the to-be-detected piece according to the inclination angle; and step S402, rotating the transmitting air-coupled transducer and the receiving air-coupled transducer on the same-side upper surface of the to-be-detected piece by adopting the rotary scanning method at present angle intervals to collect new signals, and obtaining the N groups of signal data when the transmitting air-coupled transducer and the receiving air-coupled transducer rotate by 360 degrees.

Further, in an embodiment of the disclosure, the signal change correlation coefficient is as follows:

$$ρ = \frac{{C}_{XY}}{{σ}_{X} {σ}_{Y}}$$

ρ is the signal change correlation coefficient, C_{XY}, is covariance of X and Y, X is a reference data set, Y is signal data after a period of service time, and σ_{X} and σ_{Y} are standard deviations of X and Y.

Further, in an embodiment of the disclosure, the defect distribution probability is the sum of all signal change effects of the pair of the transmitting air-coupled transducer and the receiving air-coupled transducer.

Further, in an embodiment of the disclosure, the defect distribution probability is as follows:

$$P ( x , y ) = {\sum }_{i = 1}^{N} {P}_{i} ( x , y ) = {\sum }_{i = 1}^{N} {A}_{i} [ \frac{β - {R}_{i} ( x , y )}{β - 1} ]$$

Pᵢ(x, y) is defect distribution probability estimation of the pair of the transmitting air-coupled transducer and the receiving air-coupled transducer in a multi-order symmetric mode Sᵢ, Aᵢ(x, y)=1−ρᵢ is a signal difference coefficient of the pair of the transmitting air-coupled transducer and the receiving air-coupled transducer in the multi-order symmetric mode Sᵢ, (β−Rᵢ(x, y)/(β−1) is a non-negative space distribution function of the multi-order symmetric mode Sᵢ, and the outline thereof is a group of ellipses.

In order to achieve the purposes, on the other hand, an embodiment of the disclosure provides an air-coupled ultrasonic detection device based on a defect probability reconstruction algorithm, which includes: an excitation frequency determination module, configured to determine the excitation frequency of a transmitting air-coupled transducer according to a frequency dispersion curve of guided waves and the thickness of a to-be-detected piece; an inclination angle determination module, configured to determine the group velocity of an antisymmetric mode according to the excitation frequency, and determine the inclination angle of the transmitting air-coupled transducer and a receiving air-coupled transducer according to the Snell law; a reference data acquisition module, configured to place a transmitting air-coupled transducer and a receiving air-coupled transducer on the same-side upper surface of the defect-free test piece according to the inclination angle, and obtain an initial waveform of the defect-free test piece as reference data by adopting a same-side penetration method; a signal data acquisition module, configured to place the transmitting air-coupled transducer and the receiving air-coupled transducer on the same-side upper surface of the to-be-detected piece according to the inclination angle, and obtain N groups of signal data of the to-be-detected piece by adopting the rotary scanning method; and a defect imaging module, configured to compare the reference data with the N groups of signal data, solve N signal change correlation coefficients, process the N signal change correlation coefficients based on the defect probability reconstruction algorithm to obtain the defect distribution probability on the to-be-detected piece, and carry out defect imaging on a rotating coverage area of the transmitting air-coupled transducer and the receiving air-coupled transducer according to the defect distribution probability.

According to the air-coupled ultrasonic detection device based on the defect probability reconstruction algorithm in the embodiment of the disclosure, the accuracy of traditional air-coupled ultrasonic X and Y scanning detection is improved; compared with a complex imaging technology, the air-coupled ultrasonic detection device consumes less time; and under the same environment and measurement conditions, the change is caused by the generation of defects. According to the embodiment of the disclosure, the defect growth may be monitored by tracking increase of the signal difference relative to the normal condition, and the fact health monitoring of the to-be-detected piece is realized.

In addition, the air-coupled ultrasonic detection device based on the defect probability reconstruction algorithm according to the embodiment of the disclosure may further have the following additional technical features.

Further, in one embodiment of the disclosure, the signal data acquisition module further includes: a placement unit, configured to place the transmitting air-coupled transducer and the receiving air-coupled transducer on the same-side upper surface of the to-be-detected piece according to the inclination angle; and an acquisition unit, configured to rotate the transmitting air-coupled transducer and the receiving air-coupled transducer on the same-side upper surface of the to-be-detected piece by adopting the rotary scanning method at preset angle intervals to collect new signals, and obtain the N groups of signal data when the transmitting air-coupled transducer and the receiving air-coupled transducer rotate by 360 degrees.

Further, in the embodiment of the disclosure, the signal change correlation coefficient is as follows:

$$ρ = \frac{{C}_{XY}}{{σ}_{X} {σ}_{Y}}$$

ρ is the signal change correlation coefficient, C_{XY} is covariance of X and Y, X is a reference data set, Y is signal data after a period of service time, and σ_{X} and σ_{Y} are standard deviations of X and Y.

Further, in one embodiment of the disclosure, the defect distribution probability is the sum of all signal change effects of the pair of the transmitting air-coupled transducer and the receiving air-coupled transducer.

Further, in one embodiment of the disclosure, the defect distribution probability is as follows:

$$P ( x , y ) = {\sum }_{i = 1}^{N} {P}_{i} ( x , y ) = {\sum }_{i = 1}^{N} {A}_{i} [ \frac{β - {R}_{i} ( x , y )}{β - 1} ]$$

Pᵢ(x, y) is defect distribution probability estimation of the pair of the transmitting air-coupled transducer and the receiving air-coupled transducer in a multi-order symmetric mode Sᵢ, (x, y)=1−ρᵢ is a signal difference coefficient of the pair of the transmitting air-coupled transducer and the receiving air-coupled transducer in the multi-order symmetric mode Sᵢ, (β−Rᵢ(x, y)/(β−1) is a non-negative space distribution function of the multi-order symmetric mode Sᵢ, and the outline thereof is a group of ellipses.

Additional aspects and advantages of the disclosure will be set forth in part in the following description and, in part, will be apparent from the following description, or may be learned by practice of the disclosure.

### BRIEF DESCRIPTION OF FIGURES

The above and/or additional aspects and advantages of the disclosure will become obvious and easy to understand from the description of the embodiments in conjunction with the following drawings, wherein:

FIG. 1 is a flowchart of an air-coupled ultrasonic detection method based on a defect probability reconstruction algorithm according to an embodiment of the disclosure;

FIG. 2 is a graph of variation of a guided wave dispersion characteristic curve according to an embodiment of the disclosure;

FIG. 3 is a schematic diagram of an air-coupled ultrasonic same-side penetration method for detection according to an embodiment of the disclosure;

FIG. 4 is a schematic diagram of an air-coupled ultrasonic rotary scanning method for detection according to an embodiment of the disclosure;

FIG. 5 is a schematic diagram of an ellipse distribution function of a defect probability reconstruction algorithm according to an embodiment of the disclosure; and

FIG. 6 is a schematic structural diagram of an air-coupled ultrasonic detection device based on a defect probability reconstruction algorithm according to an embodiment of the disclosure.

Description of reference numerals: 1-transmitting air-coupled transducer, 2-receiving air-coupled transducer, 3-to-be-detected piece, 10-air-coupled ultrasonic detection device based on defect probability reconstruction algorithm, 100-excitation frequency determination module, 200-inclination angle determination module, 300-reference data acquisition module, 400-signal data acquisition module and 500-defect imaging module.

### DETAILED DESCRIPTION

Embodiments of the disclosure are described in detail below, and examples of the embodiments are illustrated in the accompanying drawings. The same or similar numbers from the beginning to the end denote the same or similar elements or the elements having the same or similar functions. The embodiments described below with reference to the drawings are illustrative and intended to be explanatory of the disclosure and are not to be construed as limiting the disclosure.

An air-coupled ultrasonic detection method and device based on a defect probability reconstruction algorithm, provided by the embodiments of the disclosure, are described below with reference to the accompanying drawings, and the air-coupled ultrasonic detection method based on the defect probability reconstruction algorithm, provided by the embodiment of the disclosure, is described first with reference to the accompanying drawings.

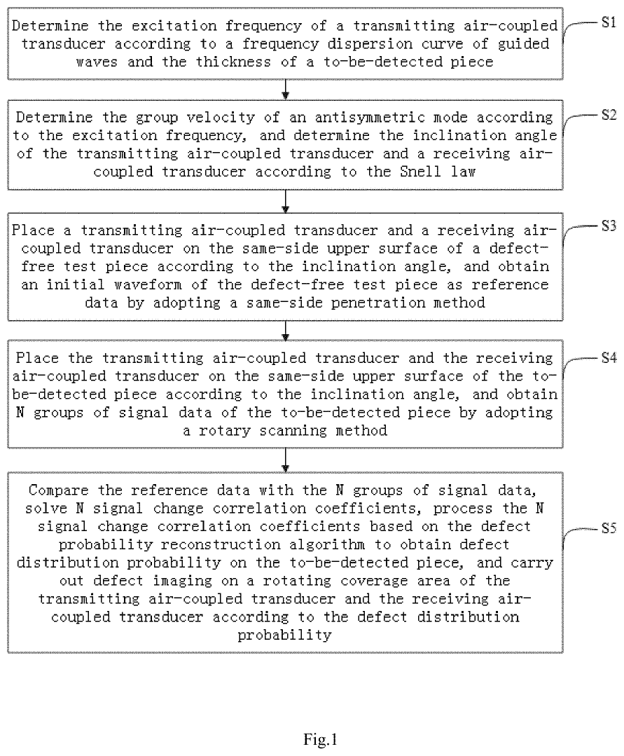

FIG. 1 is a flowchart of an air-coupled ultrasonic detection method based on a defect probability reconstruction algorithm according to an embodiment of the disclosure.

As shown in FIG. 1, the air-coupled ultrasonic detection method based on the defect probability reconstruction algorithm includes the following steps.

In step S1, the excitation frequency of a transmitting air-coupled transducer is determined according to a frequency dispersion curve of guided waves and the thickness of a to-be-detected piece.

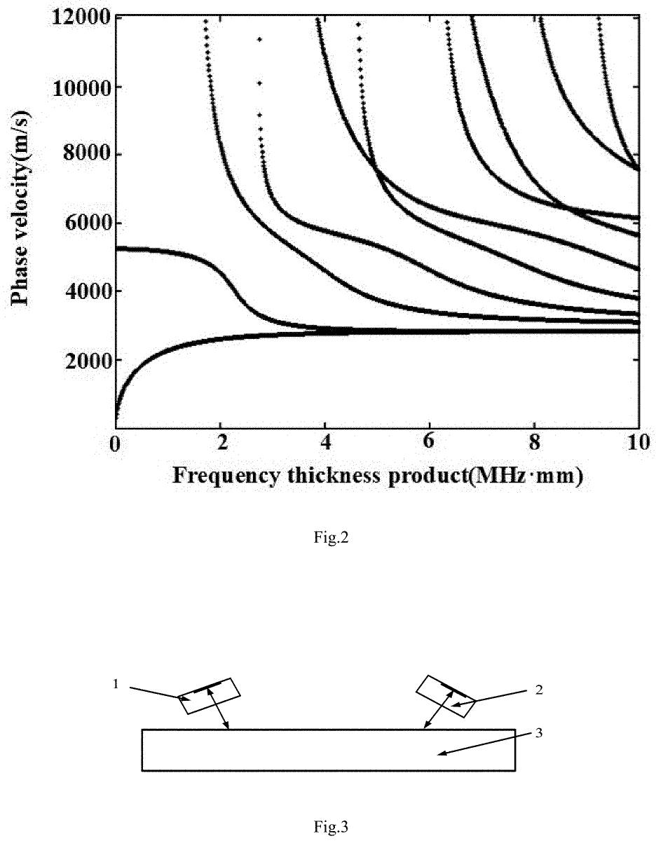

Specifically, as shown in FIG. 2, the guided waves have a symmetric mode and an antisymmetric mode as well as dispersion characteristics, and a multi-order symmetric mode (S0, S1, . . . , Si) and an antisymmetric mode (A0, A1, . . . , Ai) may be excited at the same excitation frequency. In order to excite a relatively pure mode in the to-be-detected piece by the air-coupled transducers, according to the frequency dispersion curve of the guided waves and the thickness of the to-be-detected piece, it may be known that the excitation frequency of the transmitting air-coupled transducer is smaller than a certain upper limit value, and then the excitation frequency is determined according to the actual performance of the air-coupled transducers.

In step S2, the group velocity of the antisymmetric mode is determined according to the excitation frequency, and the inclination angle of the transmitting air-coupled transducer and the receiving air-coupled transducer is determined according to the Snell law.

Specifically, those skilled in the art know from research analysis that the in-plane displacement of the symmetric mode is relatively large, and the out-of-plane displacement of the antisymmetric mode is relatively large, so that the antisymmetric mode is adopted to carry out air-coupled ultrasonic detection. After the product of frequency and thickness (the product of the frequency and the thickness of the to-be-detected piece) is determined, the group velocity of the antisymmetric mode A0 is also known, and then the inclination angle of the air-coupled transducers is determined according to the first critical refraction angle of the Snell law and the propagation velocity in air.

In step S3, a transmitting air-coupled transducer and a receiving air-coupled transducer are placed on the same-side upper surface of a defect-free test piece according to the inclination angle, and an initial waveform of the defect-free test piece is obtained as reference data by adopting a same-side penetration method.

In step S4, the transmitting air-coupled transducer and the receiving air-coupled transducer are placed on the same-side upper surface of the to-be-detected piece according to the inclination angle, and N groups of signal data of the to-be-detected piece are obtained by adopting a rotary scanning method.

Further, in an embodiment of the disclosure, step S4 specifically includes:
step S401, the transmitting air-coupled transducer and the receiving air-coupled transducer are placed on the same-side upper surface of the to-be-detected piece according to the inclination angle; and
step S402, the transmitting air-coupled transducer and the receiving air-coupled transducer are rotated on the same-side upper surface of the to-be-detected piece by adopting the rotary scanning method at present angle intervals to collect new signals, and the N groups of signal data are obtained when the transmitting air-coupled transducer and the receiving air-coupled transducer rotate by 360 degrees.

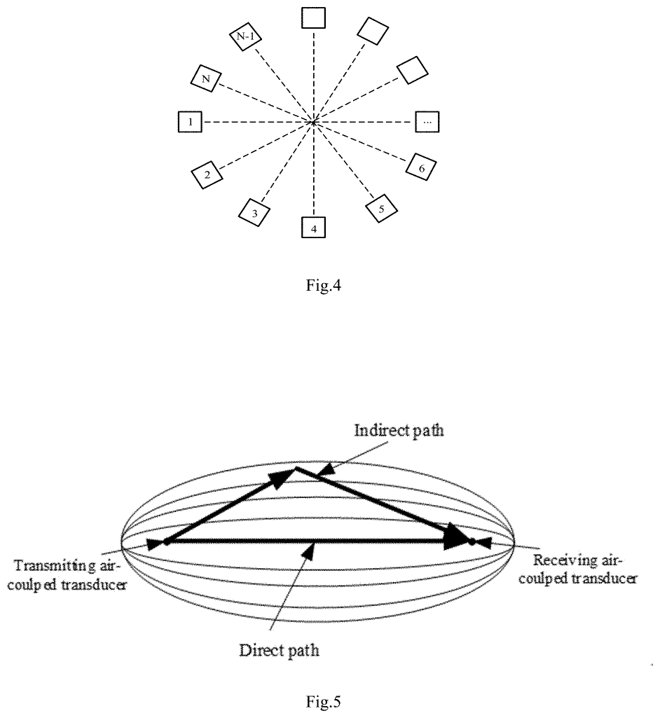

Specifically, as shown in FIG. 3 and FIG. 4, firstly, the initial waveform of the defect-free test piece is obtained as the reference data by adopting the same-side penetration method, then the transmitting air-coupled transducer and the receiving air-coupled transducer are placed on the same-side upper surface of the to-be-detected piece according to the inclination angle, and the transmitting air-coupled transducer and the receiving air-coupled transducer are rotated by taking a Z direction as an axis at preset angle intervals by adopting the rotary scanning method to collect new signals again, the rest can be done in the same manner, when the transmitting air-coupled transducer and the receiving air-coupled transducer are rotated by 360 degrees, the N groups of signal data are obtained, then the N groups of signal data are compared with the reference data, and N signal change correlation coefficients are solved to determine whether signal characteristics have great change or not.

Signal change may be represented by a signal change correlation coefficient p as follows:

$$ρ = \frac{{C}_{XY}}{{σ}_{X} {σ}_{Y}}$$

In the formula, C_{XY} is covariance of X and Y,

$${C}_{XY} = {\sum }_{k = 1}^{K} ( {X}_{k} - {μ}_{x} ) ( {Y}_{k} - {μ}_{y} )$$

In the formula, μ is an average value of various data sets, K is the length of a data set, X is a reference data set, Y is signal data after a period of service time, σ_{X} and σ_{Y} are standard deviations of X and Y.

$${σ}_{X} {σ}_{Y} = \sqrt{{\sum }_{k = 1}^{K} {( {X}_{k} - {μ}_{x} )}^{2}} \sqrt{{\sum }_{k = 1}^{K} {( {Y}_{k} - {μ}_{y} )}^{2}} .$$

In step S5, the reference data are compared with the N groups of signal data, N signal change correlation coefficients are solved, the N signal change correlation coefficients are processed based on the defect probability reconstruction algorithm to obtain defect distribution probability on the to-be-detected piece, and defect imaging is carried out on a rotating coverage area of the transmitting air-coupled transducer and the receiving air-coupled transducer according to the defect distribution probability.

That is, according to the embodiment of the disclosure, small defects are detected by measuring the difference between guided wave signals under normal conditions and guided wave signals under fault conditions based on the defect probability reconstruction algorithm.

Specifically, as shown in FIG. 5, in order to determine the location of a defect, according to an embodiment of the disclosure, it assumes that the probability of the defect occurring at a certain point may be estimated from the severity of signal change of different sensor pairs and the location of the defect relative to the sensor pairs. This means that the defect will cause the most significant signal change in the direct wave path, and if the defect is far from the direct path of the sensor pairs, the signal change effect will be reduced. The defect distribution probability in a sensor network may be expressed as the sum of all signal change effects for each pair of the transmitting air-coupled transducer and the receiving air-coupled transducer. It assumes here that in simple linearly decreased ellipse distribution, the transmitting air-coupled transducer and the receiving air-coupled transducer are arranged at the focus of an ellipse. It assumes that in a network of N total numbers of pairs of air-coupled transducers, the defect probability estimation at a location (x, y) within the reconstruction region may be written as:

$$P ( x , y ) = {\sum }_{i = 1}^{N} {P}_{i} ( x , y ) = {\sum }_{i = 1}^{N} {A}_{i} [ \frac{β - {R}_{i} ( x , y )}{β - 1} ]$$

In the formula, Pᵢ(x,y) is defect distribution probability estimation from the pair of the transmitting air-coupled transducer and the receiving air-coupled transducer in a multi-order symmetric mode Sᵢ, Aᵢ(x,y) is a signal difference coefficient of the pair of the transmitting air-coupled transducer and the receiving air-coupled transducer in the multi-order symmetric mode Sᵢ, and Aᵢ(x,y)=1−ρᵢ·(β−Rᵢ(x,y))/(β−1) is a non-negative space distribution function of the multi-order symmetric mode Sᵢ, and the outline thereof is a group of ellipses.

$${R}_{i} ( x , y ) = \{ \begin{matrix}R {D}_{i} ( x , y ) & when R {D}_{i} ( x , y ) < β \\ β & when R {D}_{i} ( x , y ) \geq β\end{matrix}$$

In the formula:

$$R {D}_{i} ( x , y ) = \frac{\sqrt{{( x - {x}_{i 1} )}^{2} + {( y - {y}_{i 1} )}^{2}} + \sqrt{{( x - {x}_{i 2} )}^{2} + {( y - {y}_{i 2} )}^{2}}}{\sqrt{{( {x}_{i 2} - {x}_{i 1} )}^{2} + {( {y}_{i 2} - {y}_{i 1} )}^{2}}}$$

is the ratio of the sum of the distance from a point (x, y) to the transmitting air-coupled transducer and the distance from the point (x, y) to the receiving air-coupled transducer in the pair of the transmitting air-coupled transducer and the receiving air-coupled transducer in the multi-order symmetric mode Sᵢ to the distance between the transmitting air-coupled transducer and the receiving air-coupled transducer. β is a scale parameter for controlling the size of an effective ellipse distribution region, and β>1. When RDᵢ, (x,y)=1 means that the point (x,y) is located on a straight line of the pair of the transmitting/receiving air-coupled transducers in the multi-order symmetric mode Sᵢ, at the moment, Pᵢ(x,y)=Aᵢ(x,y); and when RDᵢ(x,y)=β means that the point (x,y) is located on the boundary of the effective distribution region, at the moment, Pᵢ(x,y)=β. In general, β is selected to be about 1.05. If β is too small, pseudomorphism may be introduced, and if β is too large, resolution may be lost. Usually, if defects occur, a group of signals of the pair of the transmitting/receiving air-coupled transducers will be affected. Consequently, in a defect distribution probability image, compared with other points, the point where the defect is located has obvious larger probability. Therefore, the defect distribution probability is treated by using an image processing technology, for example, a threshold value of a defect estimation image is selected, a defect position may be estimated, and then, defects of the to-be-detected piece are imaged.

According to the air-coupled ultrasonic detection method based on the defect probability reconstruction algorithm provided by the embodiment of the disclosure, the accuracy of traditional air-coupled ultrasonic X and Y scanning detection is improved; compared with a complex imaging technology, the air-coupled ultrasonic detection method consumes less time; and under the same environment and measurement conditions, the change is caused by the generation of defects. According to the embodiment of the disclosure, the defect growth may be monitored by tracking increase of the signal difference relative to the normal condition, and the fact health monitoring of the to-be-detected piece is realized.

Secondly, the air-coupled ultrasonic detection device based on the defect probability reconstruction algorithm is described according to the embodiment of the disclosure by referring to the accompanying drawings.

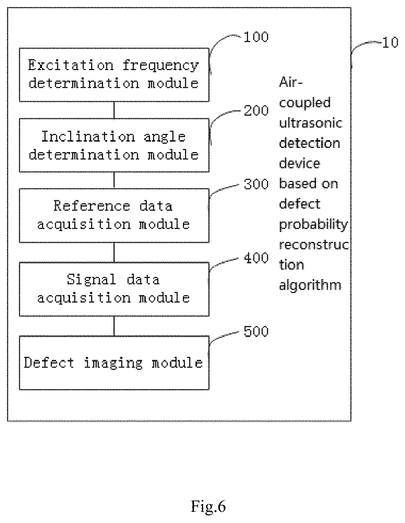

FIG. 6 is a schematic structural diagram of an air-coupled ultrasonic detection device based on the defect probability reconstruction algorithm according to an embodiment of the disclosure.

As shown in FIG. 6, the device 10 includes: an excitation frequency determination module 100, an inclination angle determination module 200, a reference data acquisition module 300, a signal data acquisition module 400 and a defect imaging module 500.

The excitation frequency determination module 100 is configured to determine the excitation frequency of a transmitting air-coupled transducer according to a frequency dispersion curve of guided waves and the thickness of a to-be-detected piece. The inclination angle determination module 200 is configured to determine the group velocity of an antisymmetric mode according to the excitation frequency, and determine the inclination angle of the transmitting air-coupled transducer and a receiving air-coupled transducer according to the Snell law. The reference data acquisition module 300 is configured to place a transmitting air-coupled transducer and a receiving air-coupled transducer on the same-side upper surface of a defect-free test piece according to the inclination angle, and obtain an initial waveform of the defect-free test piece as reference data by adopting a same-side penetration method. The signal data acquisition module 400 is configured to place the transmitting air-coupled transducer and the receiving air-coupled transducer on the same-side upper surface of the to-be-detected piece according to the inclination angle, and obtain N groups of signal data of the to-be-detected piece by adopting the rotary scanning method. The defect imaging module 500 is configured to compare the reference data with the N groups of signal data, solve N signal change correlation coefficients, process the N signal change correlation coefficients based on the defect probability reconstruction algorithm to obtain the defect distribution probability on the to-be-detected piece, and carry out defect imaging on a rotating coverage area of the transmitting air-coupled transducer and the receiving air-coupled transducer according to the defect distribution probability.

Further, in an embodiment of the disclosure, the signal data acquisition module 400 further includes: a placement unit, configured to place the transmitting air-coupled transducer and the receiving air-coupled transducer on the same-side upper surface of the to-be-detected piece according to the inclination angle; and an acquisition unit, configured to rotate the transmitting air-coupled transducer and the receiving air-coupled transducer on the same-side upper surface of the to-be-detected piece by adopting the rotary scanning method at preset angle intervals to collect new signals, and obtain the N groups of signal data when the transmitting air-coupled transducer and the receiving air-coupled transducer rotate by 360 degrees.

Further, in an embodiment of the disclosure, the signal change correlation coefficient is as follows:

$$ρ = \frac{{C}_{XY}}{{σ}_{X} {σ}_{Y}}$$

ρ is the signal change correlation coefficient, C_{XY} is covariance of X and Y, X is a reference data set, Y is signal data after a period of service time, and σ_{X} and σ_{Y} are standard deviations of X and Y.

Further, in an embodiment of the disclosure, the defect distribution probability is the sum of all signal change effects of the pair of the transmitting air-coupled transducer and the receiving air-coupled transducer.

Further, in an embodiment of the disclosure, the defect distribution probability is as follows:

$$P ( x , y ) = {\sum }_{i = 1}^{N} {P}_{i} ( x , y ) = {\sum }_{i = 1}^{N} {A}_{i} [ \frac{β - {R}_{i} ( x , y )}{β - 1} ]$$

Pᵢ(x,y) is defect distribution probability estimation of the pair of the transmitting air-coupled transducer and the receiving air-coupled transducer in a multi-order symmetric mode Sᵢ, Aᵢ(x,y)=1−ρᵢ is a signal difference coefficient of the pair of the transmitting air-coupled transducer and the receiving air-coupled transducer in the multi-order symmetric mode Sᵢ, (β−Rᵢ(x,y))/(β−1) is a non-negative space distribution function of the multi-order symmetric mode Sᵢ, and the outline thereof is a group of ellipses.

It should be noted that the explanation of the embodiment of the air-coupled ultrasonic detection method based on the defect probability reconstruction algorithm is also applicable to the device and is not repeated here.

According to the air-coupled ultrasonic detection device based on the defect probability reconstruction algorithm provided by the embodiment of the disclosure, the accuracy of traditional air-coupled ultrasonic X and Y scanning detection is improved; compared with a complex imaging technology, the air-coupled ultrasonic detection device consumes less time; and under the same environment and measurement conditions, the change is caused by the generation of defects. According to the embodiment of the disclosure, the defect growth may be monitored by tracking increase of the signal difference relative to the normal condition, and the fact health monitoring of the to-be-detected piece is realized.

In addition, terms “first” and “second” are only intended for description, but cannot be construed as indicating or implying relative importance or implicitly indicating the number of the specified technical features. Thus, the features defined with “first” and “second” may explicitly or implicitly include at least one of the features. In the description of the disclosure, the meaning of “a plurality of” is at least two, such as two and three, unless otherwise specifically defined.

In the description of the present description, descriptions with reference to terms “one embodiment”, “some embodiments”, “example”, “specific example”, or “some examples” and the like mean that specific features, structures, materials, or characteristics described in combination with the embodiments or examples are included in at least one embodiment or example of the disclosure. In the present description, the schematic representations of the foregoing terms are not necessarily directed to the same embodiment or example. Furthermore, the particular features, structures, materials, or characteristics described may be combined in a suitable manner in any one or more embodiments or examples. Moreover, those skilled in the art connect and combine different embodiments or examples described in the present description and features of different embodiments or examples without mutual conflict.

Although the embodiments of the disclosure have been shown and described above, it can be understood that the foregoing embodiments are illustrative and are not intended to be understood as limiting the disclosure. A person of ordinary skill in the art may make changes, modifications, replacements and variations to the described embodiments without departing from the scope of the disclosure.

What is claimed is:

1. An air-coupled ultrasonic detection method based on a defect probability reconstruction algorithm, comprising the following steps:
step S1, determining excitation frequency of a transmitting air-coupled transducer according to a frequency dispersion curve of guided waves and a thickness of a to-be-detected piece;
step S2, determining group velocity of an antisymmetric mode according to the excitation frequency, and determining an inclination angle of the transmitting air-coupled transducer and a receiving air-coupled transducer according to the Snell law;
step S3, placing a transmitting air-coupled transducer and a receiving air-coupled transducer on a same-side upper surface of a defect-free test piece according to the inclination angle, and obtaining an initial waveform of the defect-free test piece as reference data by adopting a same-side penetration method;
step S4, placing the transmitting air-coupled transducer and the receiving air-coupled transducer on the same-side upper surface of the to-be-detected piece according to the inclination angle, and obtaining N groups of signal data of the to-be-detected piece by adopting a rotary scanning method; and
step S5, comparing the reference data with the N groups of signal data, solving N signal change correlation coefficients, processing the N signal change correlation coefficients based on the defect probability reconstruction algorithm to obtain defect distribution probability on the to-be-detected piece, and carrying out defect imaging on a rotating coverage area of the transmitting air-coupled transducer and the receiving air-coupled transducer according to the defect distribution probability.

2. The air-coupled ultrasonic detection method based on the defect probability reconstruction algorithm according to claim 1, wherein the step S4 comprises:
step S401, placing the transmitting air-coupled transducer and the receiving air-coupled transducer on the same-side upper surface of the to-be-detected piece according to the inclination angle; and
step S402, rotating the transmitting air-coupled transducer and the receiving air-coupled transducer on the same-side upper surface of the to-be-detected piece by adopting the rotary scanning method at present angle intervals to collect new signals, and obtaining the N groups of signal data when the transmitting air-coupled transducer and the receiving air-coupled transducer rotate by 360 degrees.

3. The air-coupled ultrasonic detection method based on the defect probability reconstruction algorithm according to claim 2, wherein the signal change correlation coefficient is as follows:
$$ρ = \frac{{C}_{XY}}{{σ}_{X} {σ}_{Y}}$$
wherein ρ is the signal change correlation coefficient, C_{XY} is covariance of X and Y, X is a reference data set, Y is signal data after a period of service time, and σ_{X} and σ_{Y} are standard deviations of X and Y.

4. The air-coupled ultrasonic detection method based on the defect probability reconstruction algorithm according to claim 1, wherein the defect distribution probability is the sum of all signal change effects of the pair of the transmitting air-coupled transducer and the receiving air-coupled transducer.

5. The air-coupled ultrasonic detection method based on the defect probability reconstruction algorithm according to claim 4, wherein the defect distribution probability is as follows:
$$P ( x , y ) = {\sum }_{i = 1}^{N} {P}_{i} ( x , y ) = {\sum }_{i = 1}^{N} {A}_{i} [ \frac{β - {R}_{i} ( x , y )}{β - 1} ]$$
wherein Pᵢ(x,y) is defect distribution probability estimation of the pair of the transmitting air-coupled transducer and the receiving air-coupled transducer in a multi-order symmetric mode Sᵢ, Aᵢ(x,y)=1−ρᵢ is a signal difference coefficient of the pair of the transmitting air-coupled transducer and the receiving air-coupled transducer in the multi-order symmetric mode Sᵢ, (β−Rᵢ(x,y))/(β−1) is a non-negative space distribution function of the multi-order symmetric mode Sᵢ, and the outline thereof is a group of ellipses.

6. An air-coupled ultrasonic detection device based on a defect probability reconstruction algorithm, comprising:
an excitation frequency determination module, configured to determine the excitation frequency of a transmitting air-coupled transducer according to a frequency dispersion curve of guided waves and the thickness of a to-be-detected piece;
an inclination angle determination module, configured to determine the group velocity of an antisymmetric mode according to the excitation frequency, and determine the inclination angle of the transmitting air-coupled transducer and a receiving air-coupled transducer according to the Snell law;
a reference data acquisition module, configured to place a transmitting air-coupled transducer and a receiving air-coupled transducer on the same-side upper surface of a defect-free test piece according to the inclination angle, and obtain an initial waveform of the defect-free test piece as reference data by adopting a same-side penetration method;
a signal data acquisition module, configured to compare the reference data with N groups of signal data, solve N signal change correlation coefficients, place the transmitting air-coupled transducer and the receiving air-coupled transducer on the same-side upper surface of the to-be-detected piece according to the inclination angle, and obtain the N groups of signal data of the to-be-detected piece by adopting the rotary scanning method; and
a defect imaging module, configured to process the N signal change correlation coefficients based on the defect probability reconstruction algorithm to obtain the defect distribution probability on the to-be-detected piece, and carry out defect imaging on a rotating coverage area of the transmitting air-coupled transducer and the receiving air-coupled transducer according to the defect distribution probability.

7. The air-coupled ultrasonic detection device based on the defect probability reconstruction algorithm according to claim 6, wherein the signal data acquisition module further comprises:
a placement unit, configured to place the transmitting air-coupled transducer and the receiving air-coupled transducer on the same-side upper surface of the to-be-detected piece according to the inclination angle; and
an acquisition unit, configured to rotate the transmitting air-coupled transducer and the receiving air-coupled transducer on the same-side upper surface of the to-be-detected piece by adopting the rotary scanning method at preset angle intervals to collect new signals, and obtain the N groups of signal data when the transmitting air-coupled transducer and the receiving air-coupled transducer rotate by 360 degrees.

8. The air-coupled ultrasonic detection device based on the defect probability reconstruction algorithm according to claim 7, wherein the signal change correlation coefficient is as follows:
$$ρ = \frac{{C}_{XY}}{{σ}_{X} {σ}_{Y}}$$
wherein ρ is the signal change correlation coefficient, C_{XY} is a covariance of X and Y, X is a reference data set, Y is signal data after a period of service time, and σ_{X} and σ_{Y} are standard deviations of X and Y.

9. The air-coupled ultrasonic detection device based on the defect probability reconstruction algorithm according to claim 6, wherein the defect distribution probability is the sum of all signal change effects of the pair of the transmitting air-coupled transducer and the receiving air-coupled transducer.

10. The air-coupled ultrasonic detection device based on the defect probability reconstruction algorithm according to claim 9, wherein the defect distribution probability is as follows:
$$P ( x , y ) = {\sum }_{i = 1}^{N} {P}_{i} ( x , y ) = {\sum }_{i = 1}^{N} {A}_{i} [ \frac{β - {R}_{i} ( x , y )}{β - 1} ]$$
wherein Pᵢ(x,y) is defect distribution probability estimation of the pair of the transmitting air-coupled transducer and the receiving air-coupled transducer in a multi-order symmetric mode Sᵢ, Aᵢ(x,y)=1−ρᵢ is a signal difference coefficient of the pair of the transmitting air-coupled transducer and the receiving air-coupled transducer in the multi-order symmetric mode Sᵢ, (β−Rᵢ(x,y))/(β−1) is a non-negative space distribution function of the multi-order symmetric mode Sᵢ, and the outline thereof is a group of ellipses.
